(19) United States
(12) Patent Application Publication
(10) Pub. No.: US 2008/0022140 A1
(43) Pub. Date: Jan. 24, 2008

(54) SoC power management ensuring real-time processing

(75) Inventors: Tetsuya Yamada, Sagamihara (JP); Makoto Saen, Kodaira (JP); Satoshi Misaka, Kokubunji (JP); Keisuke Toyama, Yokohama (JP); Kenichi Osada, Tokyo (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 11/826,640

(22) Filed: Jul. 17, 2007

(30) Foreign Application Priority Data
Jul. 18, 2006 (JP) 2006-195502

(51) Int. Cl. G06F 1/26

(52) U.S. Cl. 713/322; 713/300

(57) ABSTRACT

A chip (1) includes: a resource manager (2); various kinds of functional blocks (3-6); a thermal sensor (13); and a performance counter (15). The resource manager manages tasks that the functional blocks execute, and determines a task progress (38) for each task from an activated ratio (α) provided from the performance counter and a deadline (39) contained in task information (33) and decides priority of each task. When the temperature detected by the thermal sensor during execution of a task is not less than a threshold (T_max), the resource manager reads out a power consumption budget (P_max) from a memory (9) which has been set to make the temperature below the threshold, and stops the clock fed to the functional block executing a task having a lower priority or lowers the frequency of the clock until a chip power consumption value (p_sum) becomes smaller than the power consumption budget.

### CLAIM OF PRIORITY

The Present application claims priority from Japanese application JP 2006-195502 filed on Jul. 18, 2006, the content of which is hereby incorporated by reference into this application.

### FIELD OF THE INVENTION

The present invention relates to a semiconductor integrated circuit. More specifically, it relates to a technique useful for application to a microcomputer superior in e.g. a low power consumption operation characteristic.

### BACKGROUND OF THE INVENTION

As semiconductor integrated circuits are scaled down, the scale of integration is increased. Then, large-scale semiconductor integrated circuits including an SoC (System on Chip), in which a system is configured on a chip, have been materialized. In a 90-nm or later process, a multiprocessor and many functional blocks are integrated as constituent elements of SoC. The scale of integration continues growing as described above, however SoC resources including an electric power and a memory band width remain finite. Hence, a technique to effectively make good use of the resources for integrated constituent elements has been required.

Power consumption refers to a maximum power consumption in which a device temperature is used as a shared resource, or an average power consumption in which a battery is used as a shared resource. The maximum power consumption has an influence on a device temperature. Therefore, when a guarantee temperature limit to which a device operation is guaranteed is e.g. 125° C., the maximum power consumption must be controlled to ensure a temperature below 125° C. Setting a guarantee temperature limit of a device is essential for commercialization of products to avoid thermal runaway. On this account, the following problem would appear: even if the scale of integration is increased in the future, the guarantee temperature limit of a device restricts the maximum power consumption, and therefore the number of functional blocks that an SoC contains cannot be increased. In addition, the average power consumption has an influence on the life of a battery. Therefore, to lengthen the life of a battery, it is necessary to control the average power consumption thereby to minimize power consumption. In differentiating products, it is important to make the life of a battery longer.

A technique that the maximum power consumption is managed thereby to restrict the maximum power consumption is disclosed in JP-A-2003-202935 and JP-A-2001-229040. JP-A-2003-202935 includes the following description (see Claim 10): “accepting an operation request from any of functional units, acquiring a power consumption value corresponding to the accepted functional unit from the power table, judging whether or not the power consumption falls within an allowable range of power consumption when the acquired power consumption value is used to activate the functional unit, and giving permission for the activation of the relevant functional unit only when the power consumption falls within the allowable range. That is, the technique disclosed in JP-A-2003-202935 has the following technical features, for example. First is each an operation request is accepted for each functional unit, and the permission for activation is given when the power consumption falls within the allowable range (Technical feature A). Second is the power table contains a power consumed during operation, which is a fixed value for each functional unit (Technical feature B).

JP-A-2001-229040 contains the description: “Using a period T that matches the thermal time constant, from the energy estimate 59 at a reference processor speed and the average activities derived in step 60 (particularly, effective processors speeds), it is possible to compute an average power dissipation that will be compared to thermal package model. If the power value exceeds any thresholds set forth in the package thermal model 72, the scenario is rejected in decision block 74. In this case, a new scenario is built in block 54 and steps 60, 66 and 70 are repeated. Otherwise, the scenario is used to execute the task list” (see Paragraph No. 0020). That is, the technique disclosed in JP-A-2001-229040 has the following technical features, for example. First is the power calculation is performed for each scenario; when the power value exceeds any thresholds set forth in the package thermal model, a scenario is rebuilt, otherwise the scenario is used to prepare a task list (Technical feature C). Second is the power is calculated from the average activities (Technical feature D).

### SUMMARY OF THE INVENTION

As for management of the maximum power consumption, on receipt of an operation request from a functional unit according to Technical feature A in association with JP-A-2003-202935 and on receipt of an operation request from a scenario according to Technical feature C in association with JP-A-2001-229040, it is judged in advance whether or not the maximum power consumption falls within an allowable range of power, in both the cases. Then, when the maximum power consumption falls within the allowable range, execution by the functional unit or the scenario is allowed. However, with the control including giving permission for execution in advance, e.g. in the case where the unit of processing is small and the case where the number of functional units is increased, an overhead in handshake for inquiry becomes a problem. Particularly, in real time processing which requires real-time characteristics, the overhead could interfere with an immediate response. Therefore, it is the first object of the invention to provide a semiconductor integrated circuit which can manage the maximum power consumption while performing real-time processing.

The maximum power consumption has an influence on the temperature of a device as described above. On this account, calculation of the maximum power consumption must be strict with respect to the temperature of a device. The maximum power consumption is calculated using a total value in a power table according to Technical feature B in association with JP-A-2003-202935 and using a power derived from average activities and the thermal package model according to Technical features C and D in association with JP-A-2001-229040. However, the above-described total value in the power table and average activities are less relevant to the temperature of a device, and therefore it is difficult to strictly measure the device temperature. Therefore, it is the second object of the invention to provide a semiconductor integrated circuit which enables strict measurement of a device temperature.

Incidentally, as for management of the average power consumption, it would be difficult to manage the average power consumption with high precision. This is because the power consumption value is a fixed value for each functional unit according to Technical feature B in association with JP-A-2003-202935, and average activities are used according to Technical feature D in association with JP-A-2001-229040.

The precision of calculation of power consumption would be low even with the techniques disclosed in JP-A-2003-202935 and JP-A-2001-229040 in consideration of the following facts. First is power consumption of a functional unit depends on processing information for the functional unit. Second is the leak power cannot be ignored because of miniaturization of devices. Third is the temperature has a great influence on the leak power. Therefore, it is the third object of the invention to provide a semiconductor integrated circuit which can calculate power consumption with high precision.

The above objects and novel features of the invention will be apparent from the description hereof and the accompanying drawings.

Of subject matters disclosed therein, the representative ones will be described below in brief outline.

[1] A semiconductor integrated circuit according to the invention has: a plurality of functional blocks (3 to 6) each performing a predetermined process; a resource manager (2) for managing resources of the plurality of functional blocks; a thermal sensor (13); an interrupt controller (12); and a clock control unit (16). The thermal sensor detects a temperature. The interrupt controller outputs a first interrupt signal to the resource manager when a temperature detected by the thermal sensor is not less than a threshold (31, T_max) set to be lower than a guarantee temperature limit to which an operation of the semiconductor integrated circuit (1) is guaranteed. The clock control unit controls a clock fed to each functional block. When the first interrupt signal is input, the resource manager identifies the functional block executing a process having a lower priority (Step S61) and controls the clock control unit thereby to stop the clock fed to the identified functional block (Step S63) or lower a frequency of the clock (Step S65).

According to the above-described semiconductor integrated circuit, as the temperature of the semiconductor integrated circuit is detected by the thermal sensor, the temperature can be measured exactly. When the temperature reaches or exceeds the threshold, the resource manager stops the clock of the functional block executing a process having a lower priority or lowers the speed of the execution of the process, whereby the power consumption of the functional block is reduced. Thus, the maximum power consumption during operation of the semiconductor integrated circuit is managed, and therefore thermal runaway of the semiconductor integrated circuit and the like can be avoided without fail. In addition, only the acquisition of priorities is all that is needed for the resource manager to reduce the maximum power consumption while executing a process having a high priority. Therefore, the capability to respond is not ruined, and a predetermined process is terminated by the requested time for example, whereby real-time processing can be maintained.

A specific form according to the invention further includes: a performance detector (14) for detecting information showing a processing situation in each functional block; and a performance counter (15) for accumulating the information. An accumulation value of the performance counter is an activated ratio (α) of each functional block. The resource manager calculates a progress (38) for each process based on the activated ratio and a preset finish time (39) of each process. The resource manager judges the priority to be low in descending order of the progresses when the finish time is common to the processes and in order of increasing proximity to the finish time when the finish time differs between the processes. According to the above form, the resource manager can judge the priority of a predetermined process executed in the functional block based on the accumulation value of the performance counter and the finish time.

A specific form according to the invention further includes a memory (9) for holding a power consumption budget (30C, P_max) set to make the temperature below the threshold, and a task information (33) containing a power consumption value (36, Pwr_i) for each functional block. When the first interrupt signal is input, the resource manager: updates the power consumption budget; reads out the power consumption value from the task information (Step S52); and sums up the power consumption values thereby to calculate a total power consumption value (p_sum) (Step S53). The resource manager reads out the updated power consumption budget from the memory, compares the total power consumption value with the power consumption budget (Step S67), and stops the clock fed to the identified functional block or lowers the frequency of the clock until the total power consumption value becomes smaller than the power consumption budget. According to the above form, when the first interrupt signal is input, the total power consumption value can be calculated only by reading out and summing up the power consumption value for each functional block from task information. Therefore, the maximum power consumption can be reduced in a short time, and management of the maximum power consumption can be performed at a high speed.

A specific form according to the invention further includes: a power table (40) consisting of a first table (41) showing a switching power consumption (P_act) with respect to an activated ratio of the functional block, and a second table (42) showing a leak power (P_leak) with respect to a predetermined temperature. The resource manager adds a value (P_act) of the first table depending on the activated ratio multiplied by a frequency ratio (β) showing a ratio of a frequency (freq) of the clock fed to the functional block with respect to the maximum frequency (max_freq), and a value (P_leak) of the second table depending on the predetermined temperature, calculates a power consumption value (Pwr_i) for each functional block, and enters the power consumption value in the task information. According to the above form, the power consumption value for each functional block can be calculated with high precision based on the switching power consumption obtained when the activated ratio is used as an index, the leak power obtained when the temperature is used as an index, and the frequency ratio. Further, by entering the power consumption value in the task information, the reliability of the total power consumption value calculated using the power consumption value can be increased.

In a specific form according to the invention, the first table contains mode information (MD1 to MD3) showing processing information when the process is executed. The value of the first table can be acquired according to the activated ratio and the mode information. According to the above form, the power consumption value for each functional block is calculated reflecting mode information. Therefore, the power consumption value can be calculated with higher precision.

A specific form according to the invention further includes a timer unit (7) for outputting a signal (tmr) to the interrupt controller at predetermined time intervals. The interrupt controller outputs a second interrupt signal when the temperature is below the threshold, and the signal is input. When the second interrupt signal is output, the resource manager uses the power table to calculate a power consumption value for each functional block (Step S13), and then sums up the resultant power consumption values to calculate the total power consumption value (Step S15), and compares the total power consumption value with the power consumption budget (Step S48) According to the above form, in the condition where the temperature is below the threshold, and the thermal runaway, and the like is avoided, the power consumption value is calculated by using the power table in response to the second interrupt signal which are output periodically. Therefore, the total power consumption value can be calculated with high precision periodically. Further, by comparison of the total power consumption value and the power consumption budget, the average power consumption can be managed in the condition where e.g. the total power consumption value can be reduced to be lower than the power consumption budget.

A specific form according to the invention further includes a regulator (27) for feeding a voltage for each functional block. When the first or second interrupt signal is input, the resource manager controls the regulator to lower a voltage to be fed to the identified functional block. According to the above form, the power consumption can be reduced further by not only stopping the clock of the functional block executing a process having a lower priority or making the speed of the execution lower, but also performing a low-voltage operation.

A specific form according to the invention further includes: a power switch (28) for feeding a power supply to each functional block or cutting off the power supply; and a power supply control unit (26) for controlling the power switch. When the first or second interrupt signal is input, the resource manager controls the power supply control unit, and cuts off the power supply to the identified functional block. According to the above form, the power consumption can be reduced further by not only stopping the clock of the functional block executing a process having a lower priority or making the speed of the execution lower, but also performing cutoff of power supply.

[2] A semiconductor integrated circuit according to the invention has: a plurality of functional blocks, each performing a predetermined process; a resource manager for managing resources of the plurality of functional blocks; a thermal sensor; an interrupt controller; and a clock control unit. The thermal sensor detects a temperature. The interrupt controller outputs an interrupt signal to the resource manager when a temperature detected by the thermal sensor is not less than a threshold set to be lower than a guarantee temperature limit to which an operation of the semiconductor integrated circuit is guaranteed. The clock control unit controls a clock fed to each functional block. When the interrupt signal is input, the resource manager identifies the functional block executing a process having a lower priority, and sums up power consumption values of the plurality of functional blocks to calculate a total power consumption value (Step 53). The resource manager controls the clock control unit until the total power consumption value becomes smaller than a power consumption budget set so that the temperature is below the threshold, thereby to stop the clock fed to the identified functional block (Step S63) or lower a frequency of the clock (Step S65).

According to the above-described semiconductor integrated circuit, the temperature of the semiconductor integrated circuit is detected by a thermal sensor, and therefore the temperature can be measured exactly. The resource manager calculates the total power consumption value from the power consumption value of each functional block, stops the clock to the functional block executing a process having a lower priority or making the speed of the execution lower until the total power consumption value becomes smaller than the power consumption budget, thereby reducing the power consumption of the functional block. When an arrangement like this is made, the maximum power consumption during operation of the semiconductor integrated circuit is managed, and therefore thermal runaway of the semiconductor integrated circuit and the like can be avoided without fail. In addition, the resource manager does not make an inquiry response for processing. Only the acquisition of priorities is all that is needed for the resource manager to reduce the maximum power consumption while executing a process having a high priority. Therefore, the capability to respond is not ruined, and a predetermined process is terminated by the requested time for example, whereby real-time processing can be maintained.

[3] A semiconductor integrated circuit according to the invention has: a plurality of functional blocks, each performing a predetermined process; a resource manager for managing resources of the plurality of functional blocks; a thermal sensor; a timer unit; an interrupt controller; a performance detector; a performance counter; and a clock control unit. The thermal sensor detects a temperature. The timer unit outputs a signal at predetermined time intervals. The interrupt controller outputs an interrupt signal to the resource manager when the temperature is below a threshold set to be lower than a guarantee temperature limit to which an operation of the semiconductor integrated circuit is guaranteed and the signal is input. The performance detector detects information showing a processing situation in each functional block. The performance counter accumulates the information. The clock control unit controls a clock fed to each functional block. When the interrupt signal is input, the resource manager identifies the functional block executing a process having a lower priority, and sums up power consumption values of the plurality of functional blocks to calculate a total power consumption value (Step S15). The resource manager calculates a progress for each process based on the accumulation value of the performance counter and a preset finish time for each process. When judging the process to be terminated by the finish time based on the progress (Step S42), the resource manager controls the clock control unit until the total power consumption value becomes smaller than a power consumption budget set so that the temperature is below the threshold, and stops the clock fed to the identified functional block (Step S44) or lowers the frequency of the clock(Step S46).

According to the above-described semiconductor integrated circuit, the power consumption value is calculated by use of the power table in response to an interrupt signal output periodically under the condition where the temperature is below the threshold. Thus, the total power consumption value can be calculated with high precision periodically. Further, while a comparison of the total power consumption value and power consumption budget is made, the total power consumption value is reduced until the total power consumption value becomes smaller than the power consumption budget. As a result, the average power consumption can be reduced. When an arrangement like this is made, e.g. the life of batteries can be made longer while the thermal runaway and the like are avoided.

### BRIEF DESCRIPTION OF THE DRAWINGS

FIG. 1 is a diagram schematically showing a structure of a semiconductor integrated circuit according to the first embodiment of the invention;

FIGS. 2A to 2C are conceptual illustrations for maximum power consumption control;

FIG. 3 is an explanatory view schematically showing average power consumption control and maximum power consumption control by a resource manager in the semiconductor integrated circuit;

FIG. 4 is an illustration showing an example of task management by a task management unit in the semiconductor integrated circuit;

FIG. 5 is a flowchart showing operation flows of the average power consumption control and maximum power consumption control by the resource manager;

FIG. 6 is a diagram schematically showing an example of a structure of a thermal sensor;

FIG. 7 is a flowchart showing an operation flow of calculation of a chip power consumption value for average power consumption control by a power conversion unit;

FIG. 8 is a diagram showing a circuit configuration of a performance counter;

FIG. 9 is a flowchart showing an operation flow of calculation of power consumption by the power conversion unit;

FIG. 10 is a drawing schematically showing an example of a configuration of power table used in the operation flow shown in FIG. 9;

FIG. 11 is a flowchart showing an operation flow of calculation of power consumption by the power conversion unit;

FIG. 12 is a drawing schematically showing an example of a configuration of power table used in the operation flow shown in FIG. 11;

FIG. 13 is a flowchart showing an operation flow of the average power consumption control by the power management unit;

FIG. 14 is a diagram schematically showing an example of a configuration of the clock control unit;

FIG. 15 is a flowchart showing an operation flow for calculation of a chip power consumption value for maximum power consumption control by the power conversion unit;

FIG. 16 is a flowchart showing an operation flow of maximum power consumption control by the power management unit; and

FIG. 17 is a diagram schematically showing a configuration of a semiconductor integrated circuit according to the second embodiment.

### DETAILED DESCRIPTION OF THE PREFERRED EMBODIMENTS

### First Embodiment

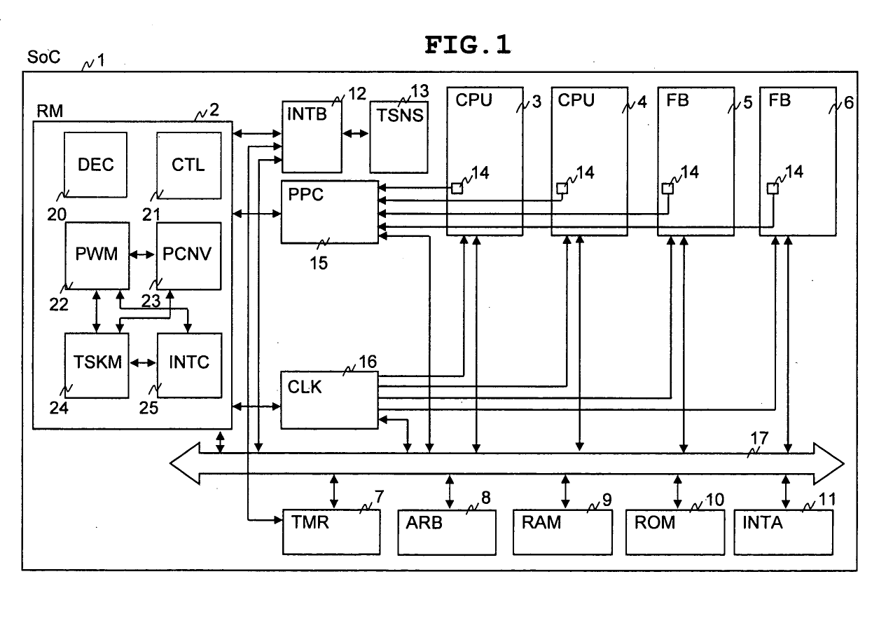

FIG. 1 schematically shows an example of a structure of a semiconductor integrated circuit in association with the first embodiment of the invention. An SoC (System on Chip, hereinafter referred to as “chip”) 1 is not limited particularly. However, it is formed on a single substrate of a semiconductor such as monocrystalline silicon by a well-known semiconductor IC technique for forming a CMOS (complementary MOS transistor), a bipolar transistor, etc. The chip 1 includes a circuit for which a guarantee temperature limit has been set; to the guarantee temperature limit, an operation of the circuit is guaranteed. The chip 1 includes, for example, a resource manager (RM) 2, CPUs 3 and 4, functional blocks (FB) 5 and 6, a timer (TMR) 7, a bus arbiter (ARB) 8, a RAM 9, a ROM 10, and an inner bus 17. Herein, the guarantee temperature limit is 125° C., for example. However the limit is not particularly limited as long as the thermal runaway or the like of the chip 1 can be avoided. The resource manager 2 manages resources of the whole chip 1 including power, and performs control of the maximum power consumption and control of the average power consumption (details of which are to be described later). The CPUs 3 and 4 are a kind of functional blocks, and perform general purpose processing. The functional blocks 5 and 6 execute particular processing, such as image processing. Hereinafter, the CPUs 3 and 4 and functional blocks 5 and 6 are also referred to as functional blocks for convenience of description. In addition, the unit of processing of the functional blocks is termed “task”. The timer 7 performs time management. The bus arbiter 8 arbitrates packets or data in the inner bus 17. The RAM 9 and ROM 10 store therein e.g. a program to be run by the resource manager 2 and fixed data. The RAM 9 stores therein a result of arithmetic operation by the resource manager 2 and makes a working area for the resource manager 2.

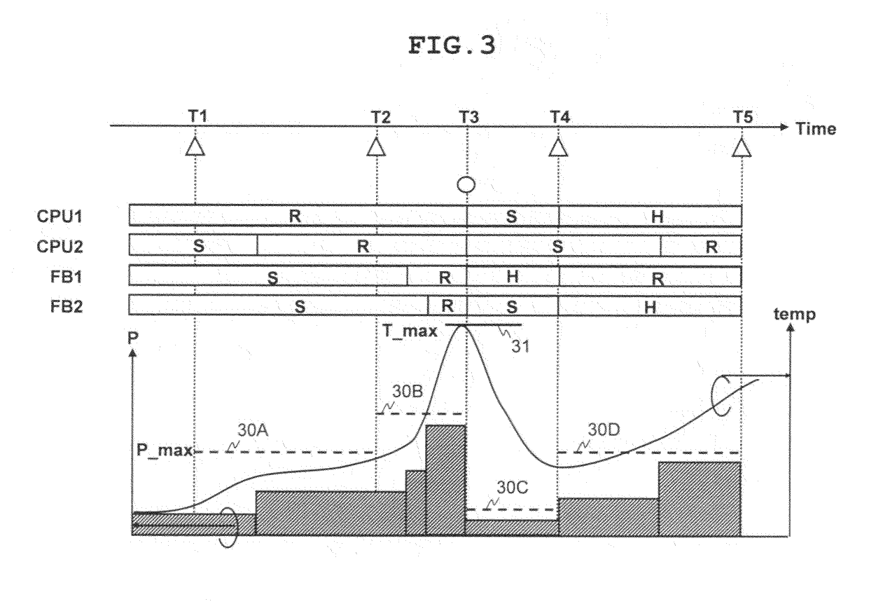

The chip 1 includes, for example, an interrupt controller (INTA) 11, an interrupt controller (INTB) 12 for the resource manager, a thermal sensor (TSNS) 13, a performance detector 14, a performance counter (PPC) 15, and a clock control unit (CLK) 16, which are connected through the inner bus 17 mutually. The interrupt controller 11 detects interruptions to the various kinds of functional blocks and judges the priorities of the interruptions. The performance detector 14 is provided in each functional block, and creates performance information showing a processing situation in the functional block. The performance counter 15 accumulates the performance information. The accumulation value of the performance information shows the activated ratio of each functional block. The thermal sensor 13 is a high-precision sensor for detecting a temperature in the chip 1 with a device. The interrupt controller 12 for the resource manager outputs a thermal sensor interrupt signal to the resource manager 2 when the temperature detected by the thermal sensor 13 is equal to or higher than a threshold (T_max) which has been set to be below the guarantee temperature limit (see FIG. 3). Also, the interrupt controller 12 for the resource manager outputs a signal sent from the timer 7 to the resource manager 2 at intervals of several milliseconds as a timer interrupt signal at intervals of several milliseconds (see FIG. 3). The timer interrupt signal serves as a timing signal for checking a situation of execution of a task and changing a power consumption budget (P_max). The timer interrupt signal is lower in priority than the thermal sensor interrupt signal. On this account, the interrupt controller 12 for the resource manager judges the priorities of the interrupt signals. Then, the interrupt controller 12 normally selects the thermal sensor interrupt signal when the temperature of the chip 1 is equal to or higher than the threshold (T_max), and selects the timer interrupt signal when the temperature is below the threshold (T_max).

The resource manager 2 includes an instruction decoder (DEC) 20, a control unit (CTL) 21, a power management unit (PWM) 22, a power conversion unit (PCNV) 23, a task management unit (TSKM) 24, and an interrupt controller (INTC) 25. The instruction decoder 20 decodes an instruction from a software program. The control unit 21 generates a control signal to be transmitted to the circuits inside the resource manager 2 based on the result of the decode. The task management unit 24 manages tasks to be processed in the chip 1 as a whole. For example, the task management unit 24 decides the priorities of the tasks to be executed in the functional blocks, the detail of which is to be described later. The power conversion unit 23 uses a power table (FIGS. 10 and 12) and calculates a power consumption value (Pwr_i) of each functional block. The interrupt controller 25 accepts the timer interrupt signal and a thermal sensor interrupt signal output by the interrupt controller 12 for the resource manager, and sends the interrupt signals to the power management unit 22.

The power management unit 22 sets the power consumption budget (P_max) in order to make the temperature detected by the thermal sensor 13 below the threshold (T_max). The power consumption budget (P_max) thus set is held by e.g. the RAM 9. The power management unit 22 calculates a chip power consumption value (p_sum) based on a power consumption value (Pwr_i) of each functional block. Also, the power management unit 22 controls the maximum power consumption so that the temperature of the chip 1 is below the threshold when the interrupt controller 25 sends a thermal sensor interrupt signal thereto. The maximum power consumption has an influence on the temperature of the chip. Therefore, to make the temperature of the chip 1 below the threshold, a chip power consumption value (P_sum), which is the result of totalization of the power consumption values (Pwr_i) of the functional blocks, must be reduced. When doing that, the power management unit 22 identifies a task with a lower priority from among tasks executed in the functional blocks, and controls the clock control unit 16 so that a clock supplied to the functional block executing the task thus identified is stopped or lowered in frequency. In addition, the power management unit 22 controls the average power consumption when receiving a timer interrupt signal from the interrupt controller 25. The average power consumption has an influence on the life of a battery. Therefore, to lengthen the life of a battery, the average power consumption must be made smaller. The maximum power consumption control and the average power consumption control will be described below.

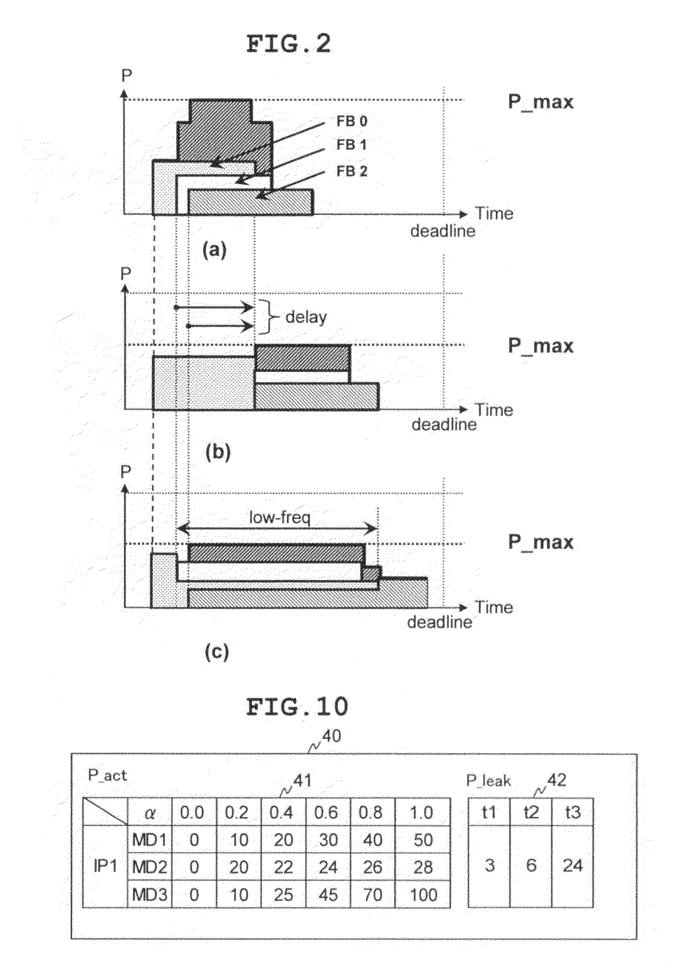

The concept of the maximum power consumption control is exemplified in FIGS. 2A to 2C. In the drawings, the horizontal axis represents time (Time), and the vertical axis represents a power per unit time (P). Further, rectangles on the coordinate axis represent powers consumed by tasks executed in the functional blocks FB0, FB1 and FB2. For each task, a deadline is set, provided that all the deadlines are set to the same time for convenience of description. A task which satisfies the requirement of the deadline will be completed by the required time, and is processed in real time. The maximum power consumption is represented by a total value of power consumption for the functional blocks at a certain time. The power consumption is represented by a total area of the rectangle for each functional block. In FIG. 2A is exemplified the case where the maximum power consumption is not controlled. In this example, the functional blocks FB0, FB1 and FB2 can execute the respective tasks in parallel. In this case, the sum of power consumption of the functional blocks FB0, FB1 and FB2 makes the maximum power consumption, i.e. power consumption budget (P_max), which is excessively large.

In FIG. 2B is exemplified the case where the maximum power consumption is controlled by means of delay. In this example, the start of execution of tasks by functional blocks FB1 and FB2 is delayed, thereby avoiding that the functional blocks FB1 and FB2 execute their tasks in parallel with execution of the task by functional block FB0. As a result, the maximum power consumption can be made smaller in comparison to the example shown in FIG. 2A, and the power consumption budget can be reduced accordingly. The maximum power consumption control like this can be performed by controlling a quantity of delay so that both the requirements for the preset power consumption budget and deadline are satisfied. In FIG. 2C is exemplified the case where the maximum power consumption is controlled by lowering an operation frequency. In this example, the functional blocks FB0, FB1 and FB2 are made to work with a low frequency (low-freq) so that both the requirements for the preset power consumption budget and deadline are satisfied, thereby making the power consumption budget smaller. The examples shown in FIGS. 2B and 2C can be materialized by the maximum power consumption control by the resource manager 2, in which the functional block executing a task with a lower priority is identified, and the clock supplied to the functional block thus identified is stopped or changed to a lower frequency. Outlines of Average power consumption control and Maximum Power Consumption Control

FIG. 3 shows examples of the outlines of the average power consumption control and maximum power consumption control by the resource manager 2. In the drawing, the horizontal axis shows time (Time), the left-side vertical axis shows a power (P), and the right-side vertical axis shows a temperature (temp). Temperatures are plotted into a curve in the drawing. Here, CPU1, CPU2, and functional blocks FB1 and FB2 are each used as a functional unit. They correspond to CPUs 3 and 4 each having formed a functional block above, and functional blocks 5 and 6, respectively. The state of each functional unit is shown by State of running (R), State of running with a half frequency (H), or State of stop (S). Also, in the drawing, the dotted lines in parallel with the horizontal axis represent power consumption budgets (P_max) 30A to 30D, and the solid line represents the threshold (T_max) 31. The average power consumption control is started with a timer interrupt signal shown by a triangle in the drawing. The timer interrupt signal is a signal which the interrupt controller 12 for the resource manager outputs to the interrupt controller 25 periodically at intervals of several milliseconds. The timer interrupt signal is output at Times T1, T2, T4 and T5. The maximum power consumption control is started with a thermal sensor interrupt signal shown by a circle in the drawing. The thermal sensor interrupt signal is a signal which the interrupt controller 12 for the resource manager outputs to the interrupt controller 25 at irregular intervals when the temperature detected by the thermal sensor 13 is equal to or higher than the threshold (T_max) 31. The thermal sensor interrupt signal is output at Time T3. In brief, the resource manager 2 performs the average power consumption control at periodic intervals, and carries out the maximum power consumption control at irregular intervals.

The outlines of the average power consumption control and maximum power consumption control by the resource manager 2 at Times T1 to T5 will be described below. The resource manager 2 sets the power consumption budget (P_max) 30A at Time T1. The power consumption budget (P_max) 30A is set so that the temperature of the chip 1 is lower than the threshold (T_max) 31. While both the CPU1 and CPU2 run for a length of time between Time T1 and Time T2, the value of power (P) of the chip 1 is smaller than the power consumption budget (P_max) 30A. Thus, the temperature of the chip 1 is made smaller than the guarantee temperature limit, and the power (P) of the chip 1 at that time falls within an allowable range.

The resource manager 2 sets the power consumption budget (P_max) 30B at Time T2. However, all of the CPU1, CPU2, and functional blocks FB1 and FB2 run at Time T3. As a result, the temperature of the chip 1 reaches the threshold (T_max) 31 as shown in the drawing. At that time, the interrupt controller 12 for the resource manager outputs a thermal sensor interrupt signal to the interrupt controller 25. Then, in order to reduce the temperature of the chip 1, the resource manager 2 lowers the power consumption budget (P_max) 30B to the power consumption budget (P_max) 30C at Time T3, and immediately stops the clock of the functional block executing the task with a lower priority or operates the block with a lower frequency thereby making smaller the power (P) of the chip 1 than the power consumption budget (P_max) 30C. Here, only the functional block FB1 operates with a half frequency and all of the other tasks are stopped. This means that the task executed by the functional block FB1 has a higher priority. Thus, the resource manager 2 can make the temperature of the chip 1 smaller than the threshold (T_max) 31.

As the above-described processing at Time T3 forces the temperature of the chip 1 to drop, the resource manager 2 increases the power consumption budget (P_max) 30C to the power consumption budget (P_max) 30D in setting at Time T4. Thus, the resource manager 2 can enlarge the number of executable tasks. For instance, in the first half period between Time T4 and Time T5, the functional block FB1 executes a task, and the CPU1 and functional block FB2 operate with half frequencies, whereas in the latter half period the CPU2 executes a task additionally.

As described above, the resource manager 2 sets the power consumption budgets (P_max) 30A, 30B and 30D according to the timer interrupt signals at Times T1, T2 and T4 in the average power consumption control, and manages tasks so that the power (P) is smaller than the power consumption budgets. Also, in the maximum power consumption control, the resource manager 2 sets the power consumption budget (P_max) 30C according to the thermal sensor interrupt signal at Time T3 to lower the temperature of the chip 1 below the threshold (T_max), and thereafter manages tasks so that the power (P) is smaller than the power consumption budget. Such task management is performed by the task management unit 24.

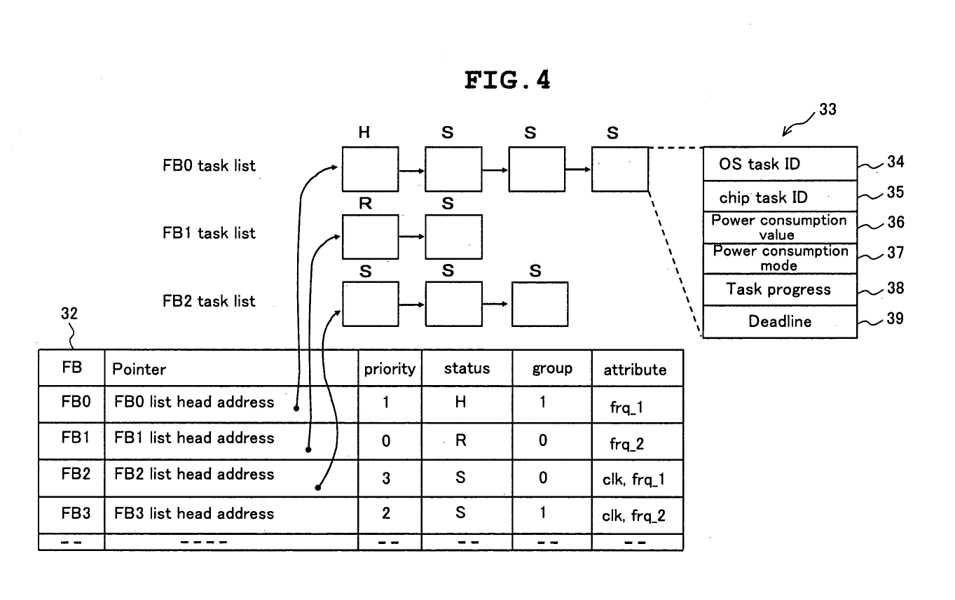

FIG. 4 shows an example of task management by the task management unit 24. The task management unit 24 manages tasks in the whole chip 1 through a software program using management tables 32. The management tables 32 are held by e.g. the RAM 9. The management tables 32 each contain a task list head address as Pointer, Priority, Status, Group Information and Attribute with respect to the corresponding one of the functional blocks FB0 to FB3. The task lists are a list in which tasks are arranged in the order of descending priorities for each of the functional blocks FB0 to FB3, and by which the tasks of each functional block are concatenated. The task lists include an FB0 task list, FB1 task list and FB2 task list. Also, the head tasks of task lists represent States of the tasks in the functional blocks FB0 to FB3. Also, each task list holds task information 33 for example. When executing a task, the task management unit 24 refers to the task information 33. The task information 33 is held in e.g. the RAM 9 or another appropriate external memory, and includes an OS task ID 34, a chip task ID 35, a power consumption value 36,a power consumption mode 37, a task progress 38 and a deadline 39. The OS task ID 34 is an ID that OS imparts to a task. The chip task ID 35 is an ID which is unified and imparted to the chip 1 by the resource manager 2 on the whole. The power consumption value 36 is a power consumption value that the task execution entails. The power consumption mode 37 is a mode showing processing information of a task. The task progress 38 shows the situation of execution of a task as described above. The deadline 39 is a finish time of a task.

The priorities of the functional blocks FB0 to FB3 are decided based on the task progress 38 and deadline 39 of the head task of each functional block, which are unique in the chip 1 and used for the average power consumption control and maximum power consumption control. The setting of the priorities will be described below specifically. First, the deadlines 39 of the functional blocks FB0 to FB3 are represented by D0, D1, D2 and D3 respectively, and the task progresses 38 are represented by P0, P1, P2 and P3, and the priorities are represented by p0, p1, p2 and p3. As one example, the following two items are assumed. The first is D1<D0=D3<D2, and the deadline of a task which has the nearest deadline 39, i.e. a task which takes the shortest time till the deadline 39 is the one represented by D1. The second is the task progresses 38 of the functional blocks FB0 and FB3 meet the relation P0<P3, and the functional block FB3 is larger than the functional block FB0 in task progress 38. In this case, when the deadlines 39 are the same, the lower the task progress 38 is, the higher the priority is. Further, when the deadlines 39 are different, the nearer the deadline 39 is, the higher the priority is. That is, the priorities meet the relation p1>p0>p3>p2. The priorities of the management tables 32 are as follows: “0” for the functional block FB1, “1” for the block FB0, “2” for the block FB3, and “3” for the block FB2, provided that the smaller the numeral enclosed by double quotation marks is, the higher the priority is. Also, to further increase the precision of the priorities, the task management unit 24 may be arranged so that it uses the function of the deadline 39 and task progress 38, F(Di,Pi) (0≦i≦3) to decide the priorities.

Status of the management table 32 shows that the corresponding functional block is in State of running (R) or State of stop (S), or the frequency which the block is running with, e.g. a half frequency (H). In the example shown in FIG. 4, Status of the functional block FB1 having the highest priority is “R,” the block FB0 with the second priority has Status “H,” and the blocks FB3 and FB2 lower in priority have Status “S.” Group of the management table 32 shows a power consumption control target group to which each functional block belongs as a target for power consumption control. When the numerals in Group are the same, the functional blocks are targeted for the same power consumption control. For example, the functional blocks FB1 and FB2 belong to Group “0.” and the blocks FB0 and FB3 belong to Group “1”; the functional blocks of each Group are controlled in parallel in cutoff of power supply or voltage control. Attribute of the management table 32 shows whether or not the clock can be stopped in power consumption control and further shows to what the frequency can be lowered. Attribute frq_1 shows that the frequency can be turned to e.g. 1-fold and 0.5-fold frequencies, but the clock cannot be stopped. Attribute frq_2 shows that the frequency can be turned to e.g. 1-fold and 0.25-fold frequencies, but the clock cannot be stopped. Functional blocks whose clock cannot be stopped include e.g. a CPU running OS. In this case, Attribute is only the frequency. Attribute clk shows that the clock can be stopped.

The task management unit 24 keeps task information 33 during the time when a task is executed or stopped. At the time of beginning execution of a task, the task lists are sent from the functional blocks FB0 to FB3 to the resource manager 2 and updated, whereby reconfiguration of the lists is performed. Calculation of the power consumption value 36 that the task information 33 contains may be performed when the list is updated or when the timer interrupt signal is generated, which is not limited particularly. However, when a timer interrupt signal is input to the resource manager 2, the resource manager 2 calculates the chip power consumption value (p_sum) which is to be described later. Hence, it is assumed in the description below that the power consumption value 36, i.e. the power consumption value (Pwr_i) of each functional block is calculated when the timer interrupt signal is input.

### Operation Flows of Average Power Consumption Control and Maximum Power Consumption Control

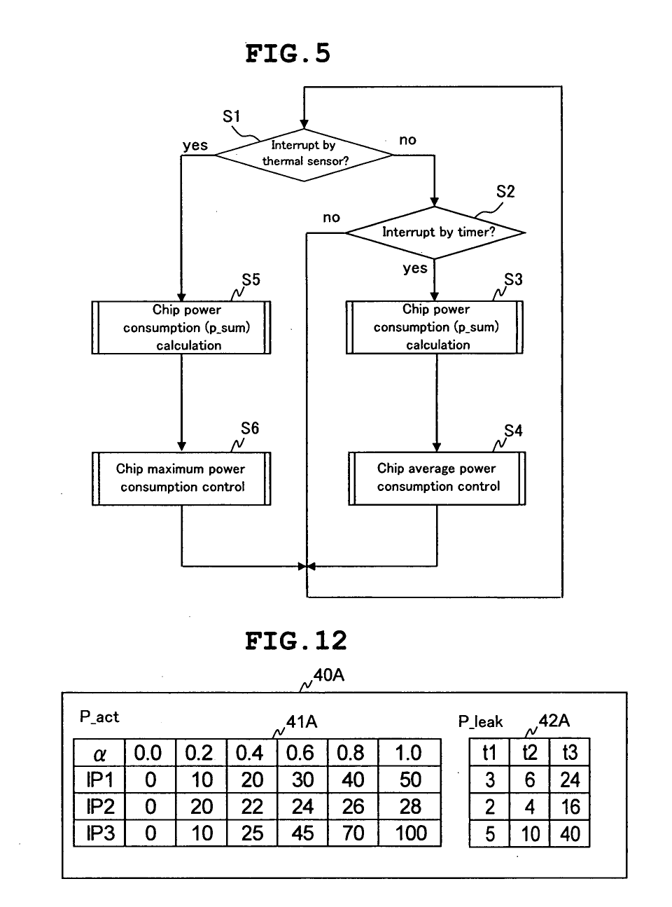

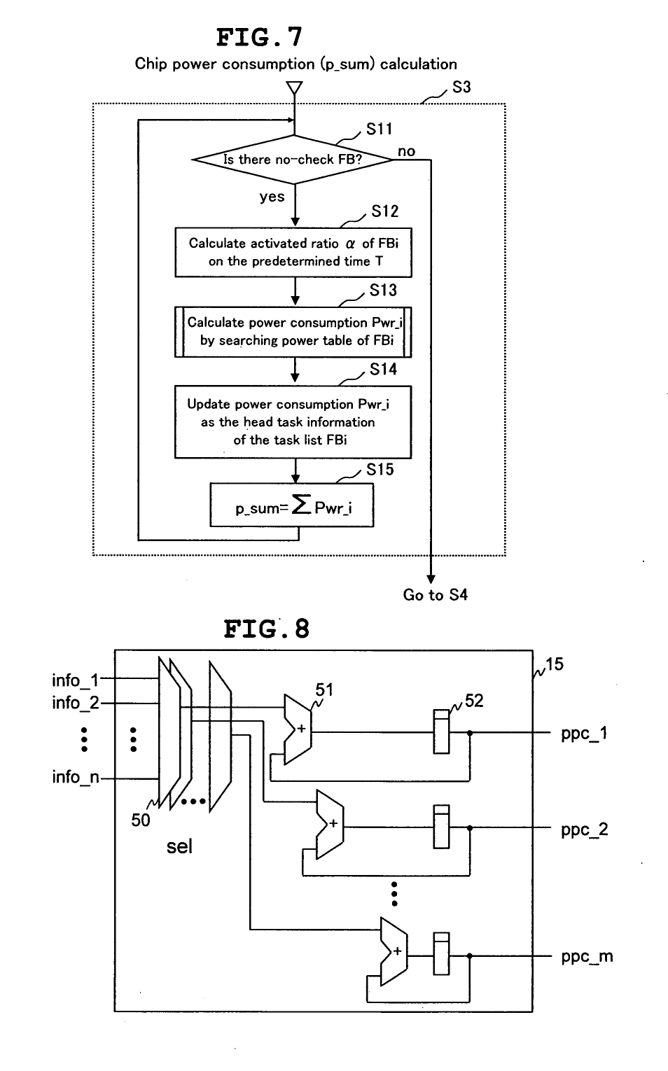

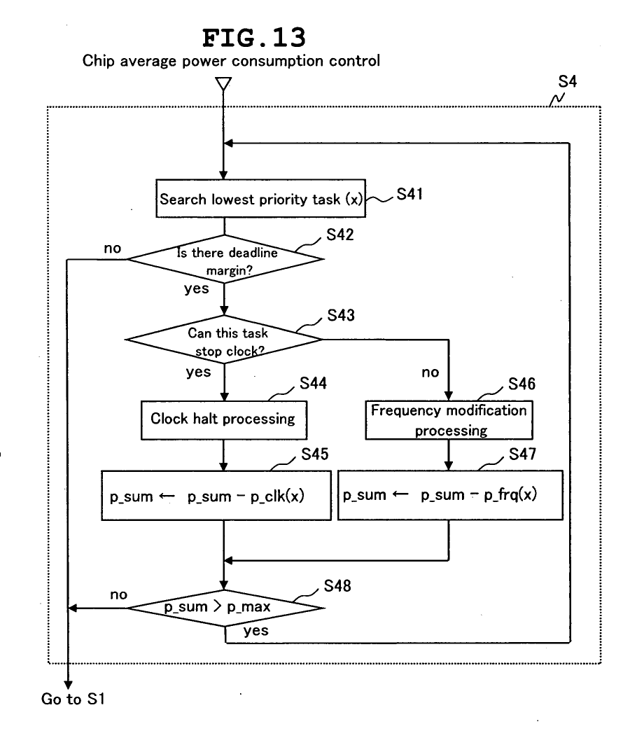

FIG. 5 shows examples of operation flows of the average power consumption control and maximum power consumption control by the resource manager 2. In the description below, the flows will be explained corresponding to the average power consumption control and maximum power consumption control executed in the time period of Time T1 to Time T5 exemplified in FIG. 3. First, the resource manager 2 judges whether or not the temperature of the chip 1 detected by the thermal sensor 13 has reached a temperature of the threshold (T_max) 31 or higher and thus the interrupt controller 12 for the resource manager has output a thermal sensor interrupt signal (Step S1). At Time T1, the temperature is lower than the threshold (T_max) 31 as described above. Therefore, the thermal sensor interrupt signal is not output, and “No” is selected in the judgment at Step S1. Second, the resource manager 2 judges whether or not the interrupt controller for the resource manager 12 has output a timer interrupt signal (Step S2). Since at Time T1 the timer interrupt signal is output as exemplified in FIG. 3, the resource manager 2 updates the power consumption value 36 that the task information 33 contains in the power conversion unit 23, and performs calculation of the chip power consumption value (p_sum) (Step S3, see FIG. 7). Then, the resource manager 2 performs chip average power consumption control in the power management unit 22 for the purpose of lowering the average power consumption of the chip 1 (Step S4, see FIG. 13). After that, the resource manager 2 returns to the process of Step S1 again. As the timer interrupt signal is not generated until Time T2, “No” is selected at Step S2, and thus the resource manager 2 returns to the process of Step S1 directly. Then, the resource manager 2 executes a series of processing of Steps S1 to S4 at Time T2.

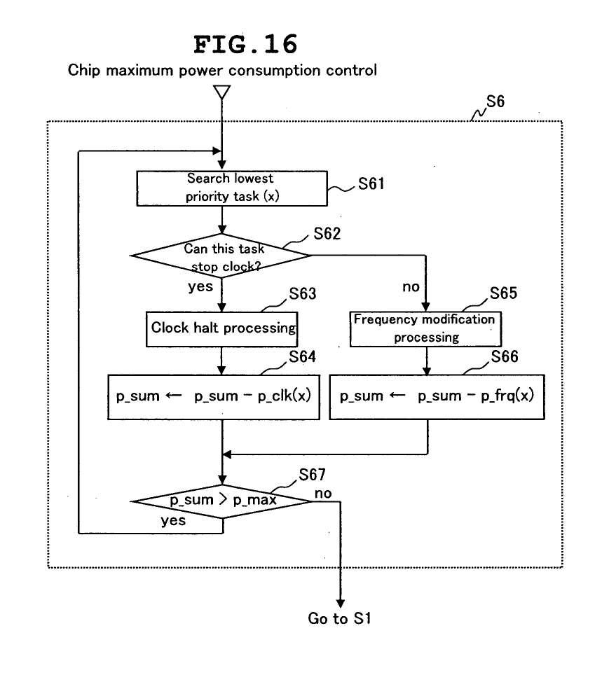

Next, after Time T2, when the time approaches Time T3, the temperature rises as exemplified in FIG. 3. Then, at Time T3 the interrupt controller 12 outputs a thermal sensor interrupt signal, and “Yes” is selected at Step S1. Hence, at Time T3 the resource manager 2 performs calculation of the chip power consumption value (p_sum) in the power conversion unit 23 using the power consumption value 36 that the task information 33 contains (Step S5, see FIG. 15). After that, the resource manager 2 performs chip maximum power consumption control in the power management unit 22 for the purpose of lowering the temperature of the chip 1 (Step S6, see FIG. 16). Subsequently, the resource manager 2 returns to the process of Step S1 again. After the temperature of the chip 1 is lowered below the threshold (T_max) 31 as a result of the chip maximum power consumption control at Step S6, when a timer interrupt signal is generated at Time T4, the resource manager 2 performs a series of processing of Steps S2 to S4. The series of processing of Steps S2 to S4 are repeated also at Time T5.

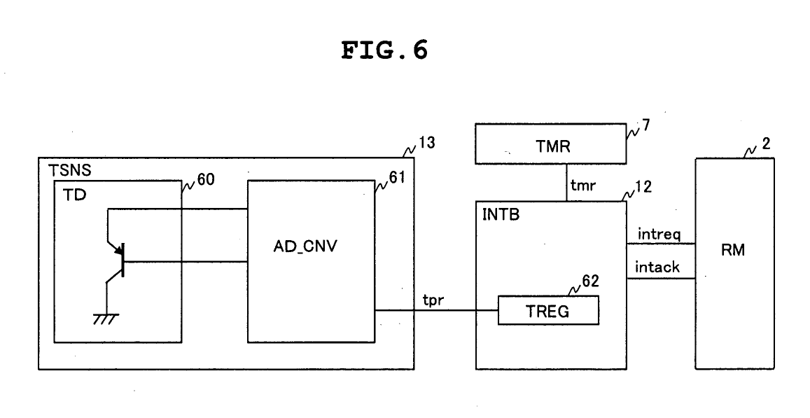

FIG. 6 shows an example of the outline of a structure of the thermal sensor 13. The thermal sensor 13 includes a thermal diode (TD) 60 and an A/D converter (AD_CNV) 61. The temperature is output from the thermal diode 60 in the form of a voltage. The voltage corresponding to the temperature is converted into a digital temperature value tpr by the A/D converter 61. The digital temperature value tpr is held by a thermal display register (TREG) 62 in the interrupt controller 12 for the resource manager. When the digital temperature value tpr is equal to or larger than the threshold (T_max) 31, the interrupt controller 12 performs handshaking of the thermal sensor interrupt signal with the interrupt controller 25 in the resource manager 2 by means of signals intreq and intack. Also, the interrupt controller 12 receives a timer interrupt tmr from the timer 7 at intervals of several milliseconds, and outputs the signal thus received to the interrupt controller 25 in the resource manager 2 as a timer interrupt signal. As the interrupt controller 25 makes a judgment with the thermal sensor interrupt signal at Step S1, and thereafter makes a judgment with the timer interrupt signal at Step S2, the thermal sensor interrupt signal is higher than the timer interrupt signal in priority. On this account, the priorities of the interrupt signals are judged in the interrupt controller 12 for the resource manager. However, the judgment of priorities may be performed by the resource manager 2.

### Calculation of Chip Power Consumption Value (p_sum) for Average Power Consumption Control

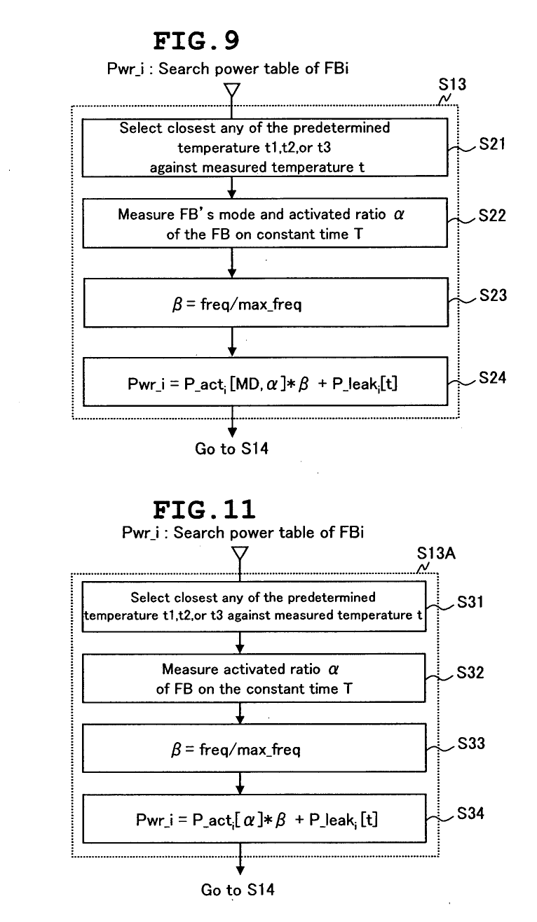

FIG. 7 shows an example of an operation flow of calculation of the chip power consumption value (p_sum) for the average power consumption control corresponding to Step S3. First, the power conversion unit 23 judges whether or not the functional blocks include a not-yet-checked functional block FB, whose power consumption value (Pwr_i) has not be calculated (Step S11). If it is judged at Step S11 that a not-yet-checked functional block FB is present, the power conversion unit 23 uses the performance counter 15 to determine an activated ratio α of i-th functional block FBi at a predetermined time T (Step S12). For example, when a functional block FB performing processing is a CPU, the activated ratio a is a ratio of an actual number of executive instructions with respect to a maximum number of executive instructions at a predetermined time T. Then, the power conversion unit 23 searches the power table (see FIG. 10) to calculate the power consumption value (Pwr_i) based on a mode MD1, MD2 or MD3 of the functional block FBi, the activated ratio α of the functional block FBi, and a temperature t detected by the thermal sensor 13 (Step S13, see FIG. 9). The modes MD1 to MD3 of the functional block FBi correspond to pieces of processing information, e.g. H.264, MPEG-4, encode and decode. The temperature t is used to calculate a leak power (P_leak) which tends to be influenced by the temperature. Then, the power conversion unit 23 updates the power consumption value (Pwr_i) 36 included in the task information 33 of the task list of the functional block FBi (Step S14). Next, the power conversion unit 23 accumulates the power consumption values (Pwr_i) of the various kinds of functional blocks FBi to determine the chip power consumption value (p_sum) (Step S15). Then, the power conversion unit 23 returns to Step S11. When having finished checking of all the functional blocks FBi, “No” is selected at Step S11 and then the power conversion unit 23 proceeds to Step S4.

A circuit configuration of the performance counter 15 is exemplified in FIG. 8. Herein as one example, the information input to the counter consists of n pieces of input information info_1 to info_n, and the value of the counter is constituted by m counter values ppc_1 to ppc_m. The performance counter 15 includes, for example, m n-to-one performance information selectors 50, m counters 51, and m flip-flops 52. The pieces of input information info_1 to info_n are an executive instruction, a cache miss, a branch, and a state of execution of a functional block FB, etc. The counter counts up with respect to selected information by means of a supplied clock. The counter values ppc_1 to ppc_m are each output as a piece of performance counter information ppc_i (1≦i≦m). Now, it is noted that when the piece of performance counter information ppc_i is used, the activated ratio a can be calculated as e.g. ppc_i/T.

An operation flow for calculating the power consumption value (Pwr_i) corresponding to Step S13 is exemplified in FIG. 9. The power conversion unit 23 searches a power table 40 exemplified in FIG. 10 and calculates the power consumption value (Pwr_i). The power table 40 is stored in e.g. the RAM 9 or an appropriate external memory, and it includes a table 41 showing a switching power consumption P_act and a table 42 showing a leak power P_leak. The table 41 shows the switching power consumption P_act as a table value, in which the activated ratio α and modes MD1 to MD3 of the functional block FB executing e.g. image processing IP1 are used as indexes. The modes MD1 to MD3 are pieces of information for discriminating individual algorithms such as MPEG-4 and H.264 and discriminating different processes such as encode and decode, for example in image processing IP1. Therefore, the modes MD1 to MD3 not only show that the task that the functional block FB executes is image processing IP1 but also reflect the difference between algorithms and the difference between processes. Thus, use of the table 41 allows the switching power consumption P_act to be set closely. The table 42 shows a leak power P_leak as a table value, in which temperatures t1, t2 and t3 are used as indexes. The temperatures t1, t2 and t3 are values previously set in the table 42. The temperatures t1, t2 and t3 are sometimes different from the temperature t that is an actually measured value detected by the thermal sensor 13. In such case, of the temperatures t1, t2 and t3, the one which is equal to or above and the nearest to the temperature t is referred to. When an arrangement like this is made, the leak power P_leak selected from the table 42 is never below the actual leak power, and the power consumption value (Pwr_i) can be calculated with a sufficient margin.

First, when the thermal sensor 13 measures the temperature t actually, the power conversion unit 23 selects, from among temperatures t1, t2 and t3 set in the table 42, the nearest value to the temperature t (Step S21). Next, the power conversion unit 23 finds the modes MD1 to MD3 and activated ratio a of the functional block FB1 for a fixed time T (Step S22), and determines a frequency ratio β, which is a ratio of a set frequency (freq) with respect to the maximum frequency (max_freq) (Step S23). Then, the power conversion unit 23 adds a value obtained by multiplying the switching power consumption P_act by the frequency ratio β, and the leak power p_leak, thereby acquiring the power consumption value (Pwr_i) (Step S24), in which the switching power consumption P_act is acquired by search of the table 41 using the activated ratio a and modes MD1 to MD3 as indexes, and the leak power P_leak is acquired by search of the table 42 using the temperatures t1, t2 and t3 as indexes. After that, the power conversion unit 23 performs the process of Step S14 as described above. Now, in regard to the power table, there is the relation of tradeoff between the precision and a memory usage, and therefore when the precision is more important than the memory usage, the precision can be raised by increasing the number of indexes or enlarging the scale, like the power table 40. Now, the operation flow for calculating the power consumption value (Pwr_i) by use of the power table in the case where it is important to reduce the memory usage will be described below.

FIG. 11 shows an example of the operation flow for calculating the power consumption value (Pwr_i) corresponding to Step S13. The power conversion unit 23 searches a power table 40A exemplified in FIG. 12 and calculates the power consumption value (Pwr_i). The power table 40A includes a table 41A showing a switching power consumption P_act and a table 42A showing a leak power P_leak. Unlike the table 41, the table 41A shows, as a table value, the switching power consumption P_act for each of processes IP1 to IP3 of functional block FB, in which only the activated ratio a is used as an index. When an arrangement like this is made, the usage of a memory by the table 41A can be reduced. Meanwhile, the table 42A shows the leak power P_leak for each of the processes IP1 to IP3. First, when the thermal sensor 13 measures the temperature t actually, the power conversion unit 23 selects, from among temperatures t1, t2 and t3 set in the table 42A, the nearest value to the temperature t (Step S31). Further, the power conversion unit 23 finds the activated ratio a of the functional block FB1 for a fixed time T (Step S32), and determines the frequency ratio β (Step S33). Then, the power conversion unit 23 adds a value obtained by multiplying the switching power consumption P_act by the frequency ratio β, and the leak power P_leak, thereby acquiring the power consumption value (Pwr_i) (Step S34), in which the switching power consumption P_act is acquired by search of the table 41A using the activated ratio α as an index, and the leak power P_leak is acquired by search of the table 42A using the temperatures t1, t2 and t3 as indexes. After that, the power conversion unit 23 performs the process of Step S14 as described above.

### Chip Average Power Consumption Control

FIG. 13 shows an example of an operation flow of average power consumption control by the power management unit 22 corresponding to Step S4. First, when a timer interrupt signal is sent from the interrupt controller 25, the power management unit 22 searches for a task having the lowest priority based on the priorities shown in the management table 32 (FIG. 4) (Step S41). For convenience of description, it is assumed here that the functional block FBx is the lowest in priority. Next, the power management unit 22 refers to a task progress 38 contained in the head task information 33 of the functional block FBx and judges whether or not the task progress 38 has a margin (Step S42). The expression “the task progress 38 has a margin” means that the task progress 38 is sufficiently high, and the deadline 39 is distant. In the case where the task progress 38 is low, and the deadline 39 is near, the task progress 38 is regarded as having no margin. When it is judged at Step S42 that the task progress 38 has a margin, the power management unit 22 judges whether or not the clock supplied to the functional block FBx can be stopped (Step S43). On the other hand, when it is judged that the task progress 38 has no margin, the power management unit 22 goes to the process of Step S1 (see FIG. 5) again. At Step S43, the judgment on whether or not the clock supplied to the functional block FBx can be stopped is made based on Attribute of the management table 32.

When supply of the clock can be stopped, the power management unit 22 controls the clock control unit 16 thereby to perform a process for stopping the clock of the functional block FBx (Step S44), and subtracts a power p_clk(x) corresponding to the power of the stopped clock from the chip power consumption value (p_sum) (Step S45). When it is judged at Step S43 that the clock cannot be stopped, the power management unit 22 performs a process for changing the frequency of the clock supplied to the functional block FBx (Step S46). Then, the power management unit 22 subtracts a power p_frq(x) corresponding the change in frequency from the chip power consumption value (p_sum) (Step S47). The power p_clk(x) corresponding to the power of the stopped clock can be obtained by e.g. referring to the power table 40 and adding a table value of the table 41 showing the switching power consumption and a table value of the table 42 showing the leak power. In addition, when the leak power is small, the table value of the table 41 maybe regarded as the power p_clk(x) corresponding to the power of the stopped clock. Further, the power p_frq(x) corresponding the change in frequency can be calculated by using e.g. the switching power consumption shown by the table 41, the leak power shown by the table 42, and the frequency ratio β. Next, the power management unit 22 judges whether or not the chip power consumption values (p_sum) obtained at Steps S45 and S47 are larger than the power consumption budget (P_max) (Step S48). The power consumption budget (P_max) is held in e.g. the RAM 9, and updated by a software program of the resource manager 2 when a timer interrupt signal is input. When it is judged at Step S48 that the chip power consumption value (p_sum) is larger than the power consumption budget (P_max), the power management unit 22 returns to the process of Step S41 again. The processes of Steps S42 to S48 are repeated until the chip power consumption value (p_sum) becomes a value equal to or below the power consumption budget (P_max). When the chip power consumption value (p_sum) becomes a value equal to or below the power consumption budget (P_max), the power management unit 22 terminates the average power consumption control. Then, the execution is returned to the process of Step S1 again. As described above, according to the average power consumption control executed in response to the timer interrupt signals at Times T1, T2, T4 and T5 (see FIG. 3), the chip power consumption value (p_sum) can be reduced within the bounds of not exceeding the deadline, i.e. not ruining the real-time characteristics. Therefore, e.g. the life of batteries can be made longer.

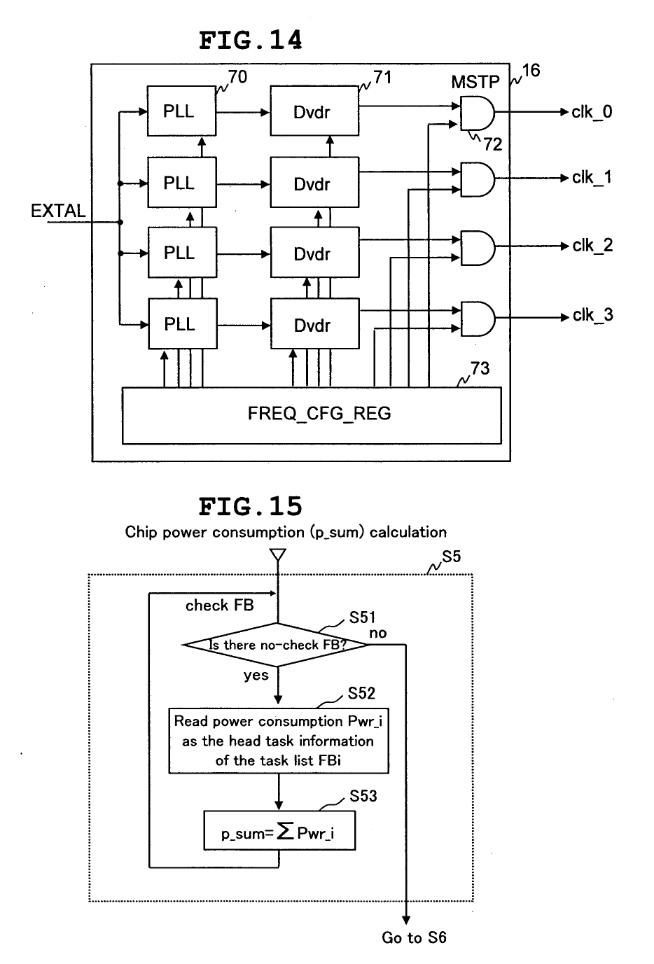

FIG. 14 schematically shows an example of a configuration of the clock control unit 16. The clock control unit 16 includes a phase-locked loop (PLL) 70, a clock divider (Dvdr) 70, an AND gate 72, and a clock control register (FREQ_CFG_REG) 73. When the clock control unit 16 accepts a clock input through a terminal EXTAL, the phase-locked loop 70 oscillates the input clock at an integral multiple frequency with respect to the input frequency, and then the clock divider 71 converts the frequency of the clock into an integral submultiple frequency. The AND gate 72 forms a final stage for a module stop (MSTP) which stops the clock for each functional block. The process for stopping the clock of each functional block corresponding to the process of Step S44, and the processes for the multiplication and the submultiple conversion corresponding to the process of Step S46 can bee executed by using a software program of the resource manager 2 to write the clock control register 73. Thus, the resource manager 2 can control stop of a clock and change in frequency for each functional block.

### Calculation of Chip Power Consumption Value (p_sum) for Maximum Power Consumption Control

FIG. 15 shows an example of an operation flow of calculation of the chip power consumption value (p_sum) for maximum power consumption control corresponding to the process of Step S5. It is important the calculation of the chip power consumption value (p_sum) in response to the thermal sensor interrupt signal is performed in a short time. This is because the temperature of the chip 1 has exceeded the threshold (T_max) and therefore top priority is put on that the temperature of the chip 1 is lowered in minimal time thereby to avoid thermal runaway of the chip 1 and the like. Hence, the power conversion unit 23 judges whether or not there is a not-yet-checked functional block FB (Step S51). When it is judged that a not-yet-checked functional block FB is present, the power conversion unit 23 does not search the power tables 40 and 40A used in the average power consumption control, and reads and accumulates the power consumption value (Pwr_i) 36 contained in the task information 33 lying in the head of the task list of each functional block FB shown in FIG. 4 (Step S52), thereby calculating the chip power consumption value (p_sum) (Step S53). Thus, the chip power consumption value (p_sum) can be calculated in a short time. Then, the power conversion unit 23 returns to Step S51. After all the functional blocks FB have been checked, “No” is selected at Step S51, and then process execution proceeds to the process of Step S6.

### Chip Maximum Power Consumption Control

FIG. 16 shows an example of an operation flow of the maximum power consumption control by the power management unit 22 corresponding to the process of Step S6. The description on the operation flow of the maximum power consumption control overlapping the average power consumption control corresponding to the process of Step S4 will be omitted here appropriately to avoid the redundancy of the description. First, the power management unit 22 refers to the priorities in the management table 32, and searches for a task having the lowest priority (Step S61). Then, if the clock can be stopped according to Attribute of the functional block FBx (“Yes” at Step S62), the power management unit 22 performs a process to stop the clock of the functional block FBx (Step S63), and then subtracts the power p_clk(x) corresponding to the power of the stopped clock from the chip power consumption value (p_sum) (Step S64). When the clock cannot be stopped (“No” at Step S62), the power management unit 22 performs a process to modify the frequency of the functional block FBx (Step S65), and then subtracts the power p_frq(x) corresponding to the change in frequency from the chip power consumption value (p_sum) (Step S66). Next, the power management unit 22 judges whether or not the chip power consumption values (p_sum) obtained at Steps S64 and S66 are larger than the power consumption budget (P_max) (Step S67). The power consumption budget (P_max) is set to a low value by a software program of the resource manager 2 in order to lower the temperature of the chip 1 when the thermal sensor interrupt signal is input. The power management unit 22 repeats the process of Steps S61 to S67 until the chip power consumption value (p_sum) becomes a value equal to or below the power consumption budget (P_max), thereby to reduce the power consumption. When the chip power consumption value (p_sum) becomes a value equal to or below the power consumption budget (P_max), the maximum power consumption control is terminated. Then, the execution is returned to the process of Step S1 again. As described above, according to the maximum power consumption control executed in response to the thermal sensor interrupt signal at Time T3 (see FIG. 3), the chip power consumption value (p_sum) can be calculated in a short time. In addition, to lower the temperature of the chip 1, the chip power consumption value (p_sum) can be reduced to a value equal to or below the power consumption budget (P_max) and therefore thermal runaway of the chip 1 and the like can be avoided while the real-time characteristics is maintained.

### Second Embodiment

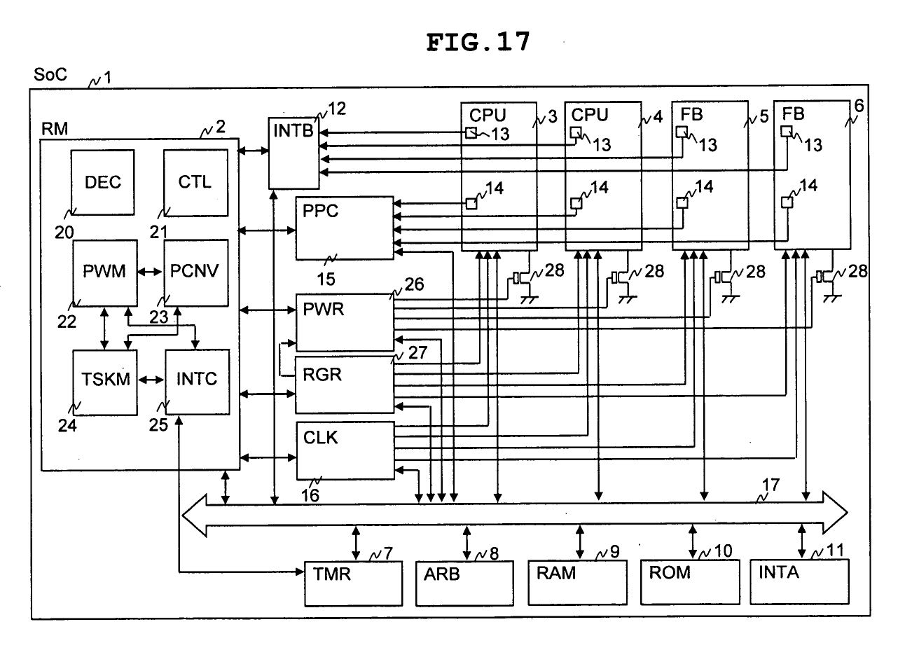

FIG. 17 schematically shows an example of a structure of a semiconductor integrated circuit in association with the second embodiment of the invention. The chip 1A is different from the chip 1 exemplified in FIG. 1 in that it includes a power supply control unit (PWR) 26, a regulator (RGR) 27 and power switches 28 additionally, and each functional block incorporates a thermal sensor (TSNS) 13. The regulator 27 supplies an optimum voltage to each functional block. The power switch 28 is for feeding and cutting off a power supply to each functional block. The power supply control unit 26 controls the power switch 28. The thermal sensor 13 is incorporated in e.g. the functional block which is expected to reach the maximum temperature while the chip 1A is working. Thus, the maximum temperature of the chip 1A can be measured precisely. Incidentally, the number of the thermal sensors 13 is not particularly limited as long as it is at least one. The highest temperatures of all the thermal sensors 13 are compared with the threshold (T_max), whereby the thermal sensor interrupt signal is generated. When doing so, the maximum power consumption control by the resource manager 2 can be started with an appropriate timing. In addition, during the average power consumption control and maximum power consumption control, the resource manager 2 uses the power supply control unit 26 to control the power switch 28 thereby to cut off the power source to the functional block with a lower priority, which enables the reduction in power consumption. Further, the resource manager 2 controls the regulator 27 thereby to lower the voltage fed to the functional block having a lower priority and makes the functional block in question work with a lower voltage, which allows the power consumption to be reduced.

The invention made by the inventor has been described based on the embodiments specifically. However, the invention is not limited to the embodiments. It is needless to say that various changes and modifications may be made without departing from the subject matter hereof.

For example, as the resource manager 2 is controlled by a software program, it may be applied to not only a semiconductor integrated circuit controlled with various instructions but also a general-purpose microcomputer, a microprocessor and the like. In addition, the managements of resources by the resource manager 2 are all controlled by a software program. Therefore, all the resource managements may be performed by a software program as a resource management task of a certain CPU, i.e. a resource management task of the resource manager 2. Further, the chip 1 can be used suitably for a car navigation system used in an environment in which the temperature is prone to rise because the maximum power consumption control by the resource manager 2 allows the temperature of the chip 1 to be lowered to a temperature equal to or below the guarantee temperature limit. Also, the chip 1 is applicable to an appropriate semiconductor products such as a mobile phone, a PDA (Personal Digital Assistant), and a digital camera because the average power consumption control by the resource manager 2 can prolong the life of batteries.

What is claimed is:

1. A semiconductor integrated circuit comprising:
a plurality of functional blocks;
a resource manager for managing resources of the plurality of functional blocks;
a thermal sensor for detecting a temperature;
an interrupt controller for outputting a first interrupt signal to the resource manager when a temperature detected by the thermal sensor is not less than a threshold set to be lower than a guarantee temperature limit to which an operation of the semiconductor integrated circuit is guaranteed; and
a clock control unit for controlling a clock fed to each functional block,
wherein when the first interrupt signal is input, the resource manager identifies the functional block executing a process having a lower priority, and controls the clock control unit thereby to stop the clock fed to the identified functional block or lower a frequency of the clock.

2. The semiconductor integrated circuit of claim 1, further comprising:
a performance detector for detecting information showing a processing situation in each functional block; and
a performance counter for accumulating the information,
wherein an accumulation value of the performance counter is an activated ratio of each functional block,
the resource manager calculates a progress for each process based on the activated ratio and a preset finish time of each process, and
the resource manager judges the priority to be low in descending order of the progresses when the finish time is common to the processes and in order of increasing proximity to the finish time when the finish time differs between the processes.

3. The semiconductor integrated circuit of claim 1, further comprising a memory for holding a power consumption budget set to make the temperature below the threshold, and task information containing a power consumption value for each functional block,
wherein when the first interrupt signal is input, the resource manager: updates the power consumption budget; reads out the power consumption value from the task information; sums up the power consumption values thereby to calculate a total power consumption value; reads out the updated power consumption budget from the memory; compares the total power consumption value with the power consumption budget; and stops the clock fed to the identified functional block or lowers the frequency of the clock until the total power consumption value becomes smaller than the power consumption budget.

4. The semiconductor integrated circuit of claim 3, further comprising a power table consisting of a first table showing a switching power consumption with respect to an activated ratio of the functional block, and a second table showing a leak power with respect to a predetermined temperature,
wherein the resource manager adds a value of the first table depending on the activated ratio multiplied by a frequency ratio showing a ratio of a frequency of the clock fed to the functional block with respect to the maximum frequency, and a value of the second table depending on the predetermined temperature, calculates a power consumption value for each functional block, and enters the power consumption value in the task information.

5. The semiconductor integrated circuit of claim 4, wherein the first table contains mode information showing processing information when the process is executed, and
the value of the first table can be acquired according to the activated ratio and the mode information.

6. The semiconductor integrated circuit of claim 4, further comprising a timer unit for outputting a signal to the interrupt controller at predetermined time intervals,
wherein the interrupt controller outputs a second interrupt signal when the temperature is below the threshold, and the signal is input, and
when the second interrupt signal is output, the resource manager uses the power table to calculate a power consumption value for each functional block, and then sums up the resultant power consumption values to calculate the total power consumption value, and compares the total power consumption value with the power consumption budget.

7. The semiconductor integrated circuit of claim 1, further comprising a regulator for feeding a voltage for each functional block,
wherein when the first or second interrupt signal is input, the resource manager controls the regulator to lower a voltage to be fed to the identified functional block.

8. The semiconductor integrated circuit of claim 1, further comprising:
a power switch for feeding or cutting off a power supply to each functional block; and
a power supply control unit for controlling the power switch,
wherein when the first or second interrupt signal is input, the resource manager controls the power supply control unit, and cuts off the power supply to the identified functional block.

9. A semiconductor integrated circuit comprising:
a plurality of functional blocks, each performing a predetermined process;
a resource manager for managing resources of the plurality of functional blocks;
a thermal sensor for detecting a temperature;
an interrupt controller for outputting an interrupt signal to the resource manager when a temperature detected by the thermal sensor is not less than a threshold set to be lower than a guarantee temperature limit to which an operation of the semiconductor integrated circuit is guaranteed; and
a clock control unit for controlling a clock fed to each functional block,
wherein when the interrupt signal is input, the resource manager identifies the functional block executing a process having a lower priority, sums up power consumption values of the plurality of functional blocks to calculate a total power consumption value, and controls the clock control unit until the total power consumption value becomes smaller than a power consumption budget set so that the temperature is below the threshold, thereby to stop the clock fed to the identified functional block or lower a frequency of the clock.

10. A semiconductor integrated circuit comprising:
a plurality of functional blocks, each performing a predetermined process;
a resource manager for managing resources of the plurality of functional blocks;
a thermal sensor for detecting a temperature;
a timer unit for outputting a signal at predetermined time intervals;
an interrupt controller for outputting an interrupt signal to the resource manager when the temperature is below a threshold set to be lower than a guarantee temperature limit to which an operation of the semiconductor integrated circuit is guaranteed and the signal is input;
a performance detector for detecting information showing a processing situation in each functional block; and
a performance counter for accumulating the information; and
a clock control unit for controlling a clock fed to each functional block,
wherein when the interrupt signal is input, the resource manager identifies the functional block executing a process having a lower priority, and sums up power consumption values of the plurality of functional blocks to calculate a total power consumption value,
the resource manager calculates a progress for each process based on the accumulation value of the performance counter and a preset finish time for each process, and
the resource manager controls the clock control unit until the total power consumption value becomes smaller than a power consumption budget set so that the temperature is below the threshold, and stops the clock fed to the identified functional block or lowers the frequency of the clock when judging the process to be terminated by the finish time based on the progress.
